(19) United States
(12) Patent Application Publication
(10) Pub. No.: US 2026/0229886 A1
(43) Pub. Date: Aug. 6, 2026

(54) METHOD OF DC UNDERVOLTAGE REGULATION AND/OR DC OVERVOLTAGE REGULATION FOR ELECTRIC POWER CONVERTER, ELECTRIC POWER CONVERTER, AND DC MICROGRID

(71) Applicant: Danfoss Drives Oy, Vaasa (FI)

(72) Inventor: Timo Mauri Rafael Alho, Vaasa (FI)

(21) Appl. No.: 19/449,810

(22) Filed: Jan. 15, 2026

(30) Foreign Application Priority Data
Jan. 31, 2025 (DE) 102025103705.1

(51) Int. Cl. H02J 1/14; H02J 105/30; H02M 1/32

(52) U.S. Cl. CPC H02J 1/14; H02M 1/32; H02J 2105/31

(57) ABSTRACT

The disclosure relates to a method of a DC undervoltage regulation and/or a DC overvoltage regulation for an electric power converter (100). The method includes monitoring (410) a DC voltage (41) by the electric power converter (100), and comparing (420) the DC voltage (41) to an undervoltage regulation limit (42; 43) and/or an overvoltage regulation limit, wherein, when the DC undervoltage regulation or the DC overvoltage regulation is in an inactivated state, the undervoltage regulation limit (42; 43) and/or the overvoltage regulation limit are/is at least partially, preferably completely, droop-compensated. The method further includes activating (430) the DC undervoltage regulation or the DC overvoltage regulation as a response to the DC voltage (41) reaching the undervoltage regulation limit (42; 43) or the overvoltage regulation limit, respectively, and regulating (440) the DC voltage (41) based on an undervoltage loading adjustment coefficient or an overvoltage loading adjustment coefficient, respectively, and finally deactivating (450).

This application claims foreign priority benefits under 35 U.S.C. § 119 to German Patent Application No. 102025103705.1 filed on Jan. 31, 2025, the content of which is hereby incorporated by reference in its entirety.

### TECHNICAL FIELD

The present invention relates in general to a direct current (DC) undervoltage and DC overvoltage regulation functionality utilized in electric power converters, such as in inverters and rectifiers. In particular, however not exclusively, the present invention concerns a DC undervoltage and DC overvoltage regulation in DC microgrids, for example, the ones used in shipboard power systems.

### BACKGROUND

Known electric power converters can have undervoltage and overvoltage regulator functionalities, if so wanted, by enabling the converter to support the DC voltage of the system, such as the common DC-link or bus voltage thereof. Enabling these functionalities is not mandatory, and in some circumstances they can also be even detrimental. For example, in motor applications, e.g. ship main propulsion, the overvoltage regulator is normally disabled, because when activated, it would start increasing the motor power by increasing its speed to limit the DC voltage rise, which is clearly an unwanted situation.

It is known that in DC microgrids the balance between power production and consumption can be observed via the DC voltage. If the DC voltage is rising, more energy is being produced than consumed, and vice versa when the voltage is dropping, the more aggressive the voltage change, the larger is the unbalance. Without balance between the production and consumption, the power system will crash due to voltage either rising too high or crashing too low and equipment trips based on operation of undervoltage and overvoltage protection functions, for instance. The undervoltage and overvoltage protection functions are, however, not the same as undervoltage and overvoltage regulator functionalities.

Since the undervoltage and overvoltage regulator functionalities are used to regulate the DC voltage, the activation of the regulator essentially changes to operation mode of the electric power converter to a voltage source. This leads to another important aspect of microgrid control in that how to enable parallel operation of multiple devices.

In theory, two voltage sources in a system can produce and measure precisely the same voltage constantly, and thus the system works just fine. In real-world, however, the system does not work like that and there are always imperfections in the equipment and measurement errors etc., and the end result is that the voltage sources e.g. measure slightly different voltages. To tackle such issues, DC voltage drooping is utilized to run multiple voltage sources in parallel, wherein voltage references of the sources are adjusted based on their loading. The drooping may, in general, be based on the following equation (1):

$${U}_{DC , ref} = {U}_{DC , NOM} ( 1 - \frac{{I}_{S}}{{I}_{NOM}} ζ ) , \qquad ( 1 )$$

where U_{DC,ref} is the DC voltage reference that is subject to the drooping, U_{DC,NOM} is the nominal voltage of the voltage source, I_{S} is the current of the voltage source, INOM is the nominal current of the voltage source, and ζ is the drooping coefficient. As can be seen, the DC voltage reference can be equal to the nominal voltage if the current is zero. On the other hand, the DC voltage reference has a predetermined DC voltage drop relative to the nominal voltage defined by the drooping coefficient if the current is equal to the nominal current. The drooping coefficient is unitless and typically significantly smaller than one.

The drooping has also been included in the undervoltage and overvoltage regulator functionalities so that the activation limit of the regulator changes also as a function of the loading. This carries, however, a real possibility that the regulator is activated in inconvenient times with the DC voltage nowhere near the wanted voltage level because the activation limit changes as a function of the loading due to the drooping. Therefore, there is still a need to develop DC undervoltage and DC overvoltage regulators that are used in electric power converters connected to a DC voltage of the system, such as of a DC microgrid.

### SUMMARY

An objective of the present invention is to provide a method of a DC undervoltage regulation and/or a DC overvoltage regulation for an electric power converter, an electric power converter, and a DC microgrid. Another objective of the present invention is that the method, the electric power converter, and the DC microgrid provide a solution for more selective activation of the DC undervoltage and DC overvoltage regulator as well as proper operation when regulating the DC voltage of the system in which the electric power converter operates.

The objectives of the invention are reached by a method of a DC undervoltage regulation and/or a DC overvoltage regulation for an electric power converter, an electric power converter, and a DC microgrid as defined by the respective independent claims.

According to a first aspect, a method of a DC undervoltage regulation and/or a DC overvoltage regulation for an electric power converter. The method comprises monitoring a DC voltage by the electric power converter. The method also comprises comparing the DC voltage to an undervoltage regulation limit and/or an overvoltage regulation limit defined at least by a user-specified or process-specified undervoltage limit and/or a user-specified or process-specified overvoltage limit, respectively, wherein, when the DC undervoltage regulation or the DC overvoltage regulation is in an inactivated state, the undervoltage regulation limit and/or the overvoltage regulation limit are/is at least partially, preferably completely, droop-compensated by utilizing an undervoltage drooping coefficient or an overvoltage drooping coefficient, respectively.

The method further comprises activating the DC undervoltage regulation or the DC overvoltage regulation as a response to the DC voltage reaching the undervoltage regulation limit or the overvoltage regulation limit, respectively, for changing the DC undervoltage regulation or the DC overvoltage regulation into an activated state. When the DC undervoltage regulation or the DC overvoltage regulation is in the activated state, the undervoltage regulation limit and/or the overvoltage regulation may, preferably, not be droop-compensated.

The method still further comprises regulating the DC voltage, when the DC undervoltage regulation or the DC overvoltage regulation is in the activated state, by adjusting loading of the electric power converter based on an undervoltage loading adjustment coefficient or an overvoltage loading adjustment coefficient, respectively, wherein the undervoltage loading adjustment coefficient and/or the overvoltage loading adjustment coefficient are/is based on a voltage difference between the undervoltage regulation limit or the overvoltage regulation limit, and the DC voltage, and based on the undervoltage drooping coefficient or the overvoltage drooping coefficient.

Furthermore, the method comprises deactivating the DC undervoltage regulation or the DC overvoltage regulation when the DC voltage becomes higher than the user-specified or process-specified undervoltage limit or the user-specified or process-specified overvoltage limit, respectively.

Preferably, after the deactivation, the DC undervoltage regulation or the DC overvoltage regulation returns to the inactivated state. Thus, the electric power converter may continue the monitoring of the DC voltage and the comparing of it to the undervoltage and/or overvoltage regulation limit(s).

The droop-compensation is, preferably, in relation to an adjustment of a reference DC voltage depending on the undervoltage drooping coefficient or the overvoltage drooping coefficient, and a loading of the electric power converter.

The user-specified limits refer to limits that may be defined by the user to be either constant limits or they may be changed by the user as desired. For example, the user may define the limit directly via an user interface of the electric power converter. On the other hand, the user may define the limits by a control system in connection with the electric power converter. The process-specified limit may refer to another device or a controller of the system in which the electric power converter is arranged to operate to define the limit, for example, defining the limit in certain cases that meet criteria for changing the limit. This may occur without direct action by the user.

Furthermore, when the DC undervoltage regulation or the DC overvoltage regulation is in the inactivated state, the loading of the electric power converter may be adjusted based on a load reference of the electric power converter.

The adjusting of the loading may comprise adjusting the loading to be at a lower level relative the load reference, when the DC undervoltage regulation is in the activated state, and/or adjusting the loading to be at a higher level relative the load reference, when the DC overvoltage regulation is in the activated state.

The undervoltage drooping coefficient and/or the overvoltage drooping coefficient may be defined based on a predetermined DC voltage drop at a nominal load in relation to the undervoltage regulation limit and/or the overvoltage regulation limit, respectively, when the DC undervoltage regulation or the DC overvoltage regulation is in the inactivated state.

Furthermore, when the DC undervoltage regulation or the DC overvoltage regulation is in the inactivated state, the undervoltage regulation limit and/or the overvoltage regulation limit may be configured to include the user-specified or process-specified undervoltage limit and/or the user-specified or process-specified overvoltage limit, respectively, and a droop-compensation term that is a function of the loading.

The undervoltage loading adjustment coefficient and/or the overvoltage loading adjustment coefficient may be a ratio of the voltage difference to a product of the undervoltage drooping coefficient or the overvoltage drooping coefficient, and the user-specified limit or process-specified undervoltage limit and/or the user-specified or process-specified overvoltage limit, respectively.

The undervoltage regulation limit may have a lower limit that is based on the DC undervoltage regulation limit when the DC undervoltage regulation is in the activated state, and a product of the load reference and the undervoltage drooping coefficient, and/or the overvoltage regulation limit may have an upper limit that is based on the overvoltage regulation limit when the overvoltage regulation is in the activated state, and a product of the load reference and the overvoltage drooping coefficient.

The method may comprise, when the DC undervoltage regulation or the DC overvoltage regulation is in the activated state: the DC voltage is required to be lower than or equal to the undervoltage regulation limit, and/or the DC voltage is required to be or equal to or higher than the overvoltage regulation limit. Thus, the DC undervoltage regulation or the DC overvoltage regulation may be deactivated when such requirement is not satisfied.

The load reference may be defined as a ratio of a reference current to a nominal current. The load reference may thus be unitless.

According to a second aspect, an electric power converter is provided. The electric power converter comprises a DC voltage bus, a conversion circuitry connected to the DC voltage bus for providing an DC/AC, an AC/DC, or a DC/DC voltage conversion, voltage determining means, such as one or more voltage sensors, for determining a DC voltage of the DC voltage bus, current determining means, such as one or more current sensors, for determining a load current of the electric power converter, and a controller that is configured to perform the method in accordance with the first aspect.

The controller may be configured, when the DC undervoltage regulation or the DC overvoltage regulation is in the inactivated state, to control a loading of the electric power converter in accordance with a load reference of the electric power converter.

The electric power converter may comprise a capacitor or a capacitor bank, or a battery or a battery bank connected to the DC voltage bus.

The electric power converter may be an inverter or a rectifier.

According to a third aspect, a DC microgrid is provided. The DC microgrid comprises a common DC bus having a DC voltage, one or several DC voltage sources connected to the common DC bus, and one or several electric power converters in accordance with the second aspect connected to the common DC bus. The DC microgrid may be arranged as a shipboard power system.

The present invention provides a method of a DC undervoltage regulation and/or a DC overvoltage regulation for an electric power converter, an electric power converter, and a DC microgrid. The present invention provides advantages over known solutions in that the DC undervoltage regulation and/or the DC overvoltage regulation is activated in correct times and also deactivated when not needed anymore. The electric power converter may operate in a network, such as in a DC microgrid, e.g. of a ship, to regulate DC voltage thereof based on monitoring the DC voltage, and therefore without a need to have a complex centralized control for all devices of the network.

Various other advantages will become clear to a skilled person based on the following detailed description.

The terms “first” and “second” are herein used to distinguish one element from other element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended patent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF THE DRAWINGS

Some embodiments of the invention are illustrated by way of example, and not by way of limitation, in the figures of the accompanying drawings.

FIG. 1 illustrates schematically an electric power converter.

FIG. 2 illustrates schematically an electric power converter.

FIG. 3 illustrates schematically a DC microgrid.

FIG. 4 shows a flow diagram of a method of a DC undervoltage regulation and/or a DC overvoltage regulation for an electric power converter.

FIG. 5 illustrates operation of an electric power converter that is configured with a DC undervoltage regulation and/or a DC overvoltage regulation.

### DETAILED DESCRIPTION

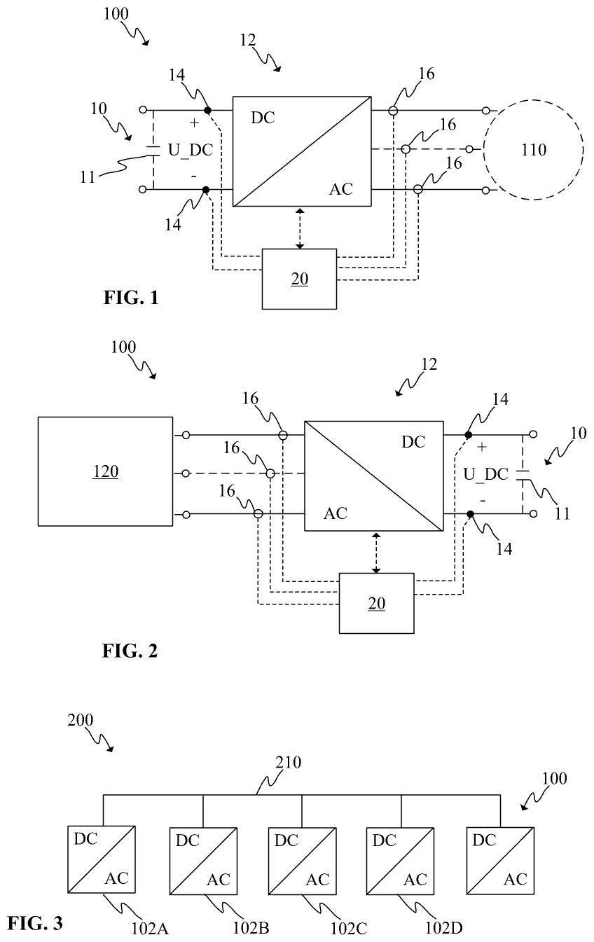

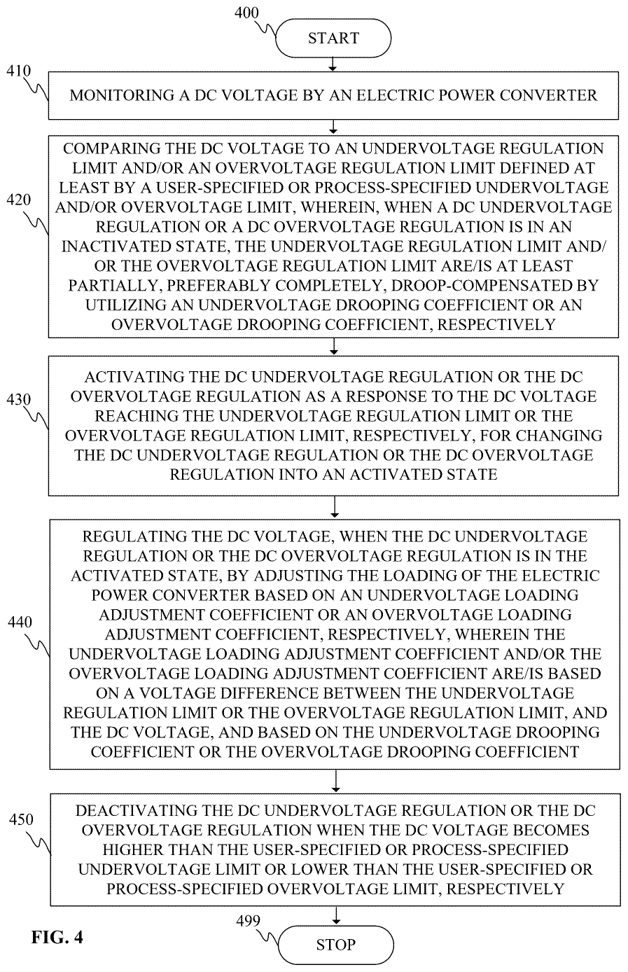

FIG. 1 illustrates schematically an electric power converter 100 comprising a DC voltage bus 10, a conversion circuitry 12 connected to the DC voltage bus 10 for providing an DC/AC, an AC/DC, or a DC/DC voltage conversion, voltage determining means 14, such as one or more voltage sensors, for determining a DC voltage U_DC of the DC voltage bus 10, and current determining means 16, such as one more current sensors, for determining a load current of the electric power converter 10. The electric power converter 100 further comprises a controller 20. The controller 20 may be configured to perform some or all method steps described in connection with FIG. 4 described hereinbelow.

The controller 20 may be arranged to receive voltage measurement data from the voltage determining means 14 and current measurement data from the current determining means 16. The electric power converter 100 of FIG. 1 may be an inverter converting DC at its input to AC at its output, optionally to operate an electric motor 110 connected to the output, for instance.

Furthermore, the controller 20 may be configured to provide control signal(s) to the conversion circuitry 12, for example, to switch semiconductor power switches to produce desired output waveform. This may include using a pulse-width modulation (PWM) technique.

The controller 20 may be configured to perform a current control and/or a voltage control (not shown). The current control and/or the voltage control may include use of scalar control or vector control as is known to a skilled person in the art.

The controller 20 may be configured, when a DC undervoltage regulation or a DC overvoltage regulation is in an inactivated state, to control a loading of the electric power converter 100 in accordance with a load reference. The load reference may be user-specified or process-specified. The load reference may be defined as a ratio of a reference current to a nominal current. For example, the reference current at a given time instance may be 15 amperes, and the nominal current of the electric power converter 100 may be 100 amperes, thereby providing the load reference of 0.15.

The electric power converter 100 may comprise a capacitor 11 or a capacitor bank, or a battery 11 or a battery bank connected to the DC voltage bus 10. The capacitor 11 or the capacitor bank, or the battery 11 or the battery bank may be utilized as an energy storage and/or a filter device for smoothing the DC voltage of the DC voltage bus 10.

FIG. 2 illustrates schematically an electric power converter 100 comprising a DC voltage bus 10, a conversion circuitry 12 connected to the DC voltage bus 10 for providing an DC/AC, an AC/DC, or a DC/DC voltage conversion, voltage determining means 14, such as one or more voltage sensors, for determining a DC voltage U_DC of the DC voltage bus 10, and current determining means 16, such as one more current sensors, for determining a load current of the electric power converter 10. The electric power converter 100 further comprises a controller 20. The controller 20 may be arranged to receive voltage measurement data from the voltage determining means 14 and current measurement data from the current determining means 16. The electric power converter 100 of FIG. 1 may be a rectifier converting AC at its input to DC at its output, optionally to operate an electric generator 120 connected to the output, for instance. The controller 20 in FIG. 2 may be substantially similar to that described in connection with FIG. 1.

As can be realized, the inverter of FIG. 1 may be structurally substantially similar to the rectifier of FIG. 2, however, the main direction of power flow is different. In some embodiments, the electric power converter 100 may be bidirectional in that electric power can be selectively made to flow in either one of the said directions.

FIG. 3 illustrates schematically a DC microgrid 200. The DC microgrid 200 comprises a common DC bus 210 having a DC voltage, one or several DC voltage sources 102A-102D connected to the common DC bus 210, and one or several electric power converters 100 connected to the common DC bus 210. The DC microgrid 200 may be, however, not necessarily, arranged as a shipboard power system. Even though it is shown that the number of DC voltage sources 102A-102D is four and there is only one electric power converter 100, the numbers could as well be different, depending on the DC microgrid 200.

As can be seen, the DC voltage of the common DC bus 210 is connected to each of the devices, namely the (one or) several DC voltage sources 102A-102D and the one (or several) electric power converters 100. Thus, they are arranged to operate in parallel to each other. In case the DC voltage becomes too high or too low, the one or several electric power converters 100 may start to regulate the DC voltage of the common DC bus 210 by activating the overvoltage or undervoltage regulation functionality, respectively.

FIG. 4 shows a flow diagram of a method of a DC undervoltage regulation and/or a DC overvoltage regulation for an electric power converter 100, such as the ones shown in and described in connection to FIGS. 1 and 2.

Item or step 400 refers to an optional start-up phase of the method. Suitable equipment and components are obtained, and systems assembled and configured for operation, if these have not previously been set up.

As stated hereinbefore, at least part of the method steps, if not all, may be performed by the controller 20 of the electric power converter 100.

Item or method step 410 refers to monitoring a DC voltage by the electric power converter 100. The monitoring 410 may be done continuously or in certain intervals, for instance. The monitoring 410, such as including measuring, may be done during times when the DC undervoltage regulation and/or the DC overvoltage regulation is in in an inactivated state or an activated state.

Item or method step 420 refers to comparing the DC voltage to an undervoltage regulation limit and/or an overvoltage regulation limit defined at least by a user-specified or process-specified undervoltage limit and/or a user-specified or process-specified overvoltage limit, wherein, when the DC undervoltage regulation or the DC overvoltage regulation is in an inactivated state, the undervoltage regulation limit and/or the overvoltage regulation limit are/is at least partially, preferably completely, droop-compensated by utilizing an undervoltage drooping coefficient or an overvoltage drooping coefficient, respectively.

In some embodiments, the droop-compensation may be in relation to an adjustment of a reference DC voltage depending on the undervoltage drooping coefficient or the overvoltage drooping coefficient, and a loading of the electric power converter.

Furthermore, when the DC undervoltage regulation or the DC overvoltage regulation is in the inactivated state, the undervoltage regulation limit and/or the overvoltage regulation limit may be configured to include the user-specified or process-specified undervoltage limit and/or the user-specified or process-specified overvoltage limit, and a droop-compensation term that is a function of the loading. For example, the undervoltage regulation limit may be configured to be defined as follows:

$${U}_{UV \_ LIM} = {U}_{UV \_ USER} ( 1 + \frac{I}{{I}_{NOM}} {ζ}_{U V} ) , \qquad ( 2 A )$$

where U_{UV_LIM} is the undervoltage regulation limit, U_{UV_USER} is the user-specified or process-specified undervoltage limit, I is the load current or reference current of the electric power converter 100, I_{NOM} is the nominal current of the of the electric power converter 100, and ζ_{UV} is the undervoltage drooping coefficient. The part in the parentheses represents the droop-compensation term that is a function of the loading, namely the ratio of the load current or the reference current, to the nominal current. A similar kind of equation can be defined for the overvoltage regulation limit as well, that is,

$${U}_{OV \_ LIM} = {U}_{OV \_ USER} ( 1 + \frac{I}{{I}_{NOM}} {ζ}_{OV} ) , \qquad ( 2 B )$$

where U_{OV_LIM} is the overvoltage regulation limit, U_{OV_USER} is the user-specified or process-specified overvoltage limit, I is the load current or reference current of the electric power converter 100, I_{NOM} is the nominal current of the of the electric power converter 100, and ζ_{OV} is the undervoltage drooping coefficient. The droop-compensation term may partly or, preferably, completely remove the effect of drooping.

Furthermore, when the DC undervoltage regulation or the DC overvoltage regulation is in the inactivated state, the loading of the electric power converter may be adjusted based on the load reference, such as, based on a relation or the ratio between the reference current and the nominal current of the electric power converter 100. This may indeed be dependent on the power needs of the device or the process, such as including an electric motor 110, connected to the electric power converter 100.

Item or method step 430 refers to activating the DC undervoltage regulation or the DC overvoltage regulation as a response to the DC voltage reaching the undervoltage regulation limit or the overvoltage regulation limit, respectively, for changing the DC undervoltage regulation or the DC overvoltage regulation into an activated state.

In various embodiments, the activation, thus, occurs at a set voltage value, such as the user-specified or process-specified undervoltage or overvoltage limit, since the limit is droop-compensated during times when the DC undervoltage regulation or the DC overvoltage regulation is in the inactivated state. The user can, thus, rely that the activation happens at correct times.

When the DC undervoltage regulation or the DC overvoltage regulation is in the activated state, the undervoltage regulation limit and/or the overvoltage regulation may, preferably, not be droop-compensated.

Item or method step 440 refers to regulating the DC voltage, when the DC undervoltage regulation or the DC overvoltage regulation is in the activated state, by adjusting the loading of the electric power converter based on an undervoltage loading adjustment coefficient or an overvoltage loading adjustment coefficient, respectively, wherein the undervoltage loading adjustment coefficient and/or the overvoltage loading adjustment coefficient are/is based on a voltage difference between the undervoltage regulation limit or the overvoltage regulation limit, and the DC voltage, and based on the undervoltage drooping coefficient or the overvoltage drooping coefficient.

The undervoltage drooping coefficient and/or the overvoltage drooping coefficient may be defined based on a predetermined DC voltage drop at a nominal load in relation to the undervoltage regulation limit and/or the overvoltage regulation limit, respectively.

For example, in case the DC undervoltage is activated, the loading of the electric power converter 100 may be lowered relative to the load reference that the electric power converter 100 would otherwise follow or the respective loading that the converter 100 would try to provide. In case the DC overvoltage is activated, the loading of the electric power converter 100 may be increased relative to the load reference that the electric power converter 100 would otherwise follow or the respective loading that the converter 100 would try to provide. This way the DC voltage can be regulated by improving the power balance conditions, that is, between power production and power consumption.

The adjusting of the loading may, thus, comprise adjusting the loading to be at a lower level relative the load reference, when the DC undervoltage regulation is in the activated state, and/or adjusting the loading to be at a higher level relative the load reference, when the DC overvoltage regulation is in the activated state.

The undervoltage loading adjustment coefficient and/or the overvoltage loading adjustment coefficient may be configured to determine an amount of contribution from the electric power converter 100 for regulating the DC voltage, when the DC undervoltage regulation or the DC overvoltage regulation is in the activated state. Thus, the higher the voltage difference, the higher the contribution may be for a specific the undervoltage drooping coefficient or the overvoltage drooping coefficient.

In some embodiments, when the DC undervoltage regulation or the DC overvoltage regulation is in the activated state, the undervoltage loading adjustment coefficient and/or the overvoltage loading adjustment coefficient may be a ratio of the voltage difference to a product of the undervoltage drooping coefficient or the overvoltage drooping coefficient, and the user-specified limit or process-specified undervoltage or overvoltage limit, respectively. They may, thus, be configured to be defined as follows:

$${Γ}_{U V} = \frac{{U}_{UV \_ LIM} - {U}_{DC}}{{U}_{UV \_ USER} \cdot {ζ}_{U V}} , \qquad ( 3 A )$$

$${Γ}_{OV} = \frac{{U}_{OV \_ LIM} - {U}_{DC}}{{U}_{OV \_ USER} \cdot {ζ}_{OV}} , \qquad ( 3 B )$$

where Γ_{UV} is the undervoltage loading adjustment value, Γ_{OV} the overvoltage loading adjustment value, U_{UV_LIM} and U_{OV_LIM} are the undervoltage regulation limit and the overvoltage regulation limit, respectively, U_{DC} is the DC voltage of the electric power converter 100, and ζ_{UV} and ζ_{OV} are the undervoltage and overvoltage drooping coefficients, respectively. In this case, when the DC undervoltage regulation or the DC overvoltage regulation is in the activated state, the undervoltage regulation limit and the overvoltage regulation limit are not droop-compensated.

Furthermore, when the DC undervoltage regulation or the DC overvoltage regulation is in the activated state, the undervoltage regulation limit may have a lower limit that is based on the DC undervoltage regulation limit when the DC undervoltage regulation is in the activated state, and a product of the load reference and the undervoltage drooping coefficient, and/or the overvoltage regulation limit may have an upper limit that is based on the overvoltage regulation limit when the overvoltage regulation is in the activated state, and a product of the load reference and the overvoltage drooping coefficient.

In some embodiments, the lower limit and/or the upper limit may be configured to be defined as follows:

$${U}_{UV \_ LIM \_ MIN} = {U}_{UV \_ USER} ( 1 + K {ζ}_{UV} ) , \qquad ( 4 A )$$

$${U}_{OV \_ LIM \_ MAX} = {U}_{OV\_USER} ( 1 + K {ζ}_{OV} ) , \qquad ( 4 B )$$

where U_{UV_LIM_MIN} and U_{OV_LIM_MAX} are the lower limit and the upper limit, and K is the load reference. The load reference K may be defined as a ratio of a reference current to a nominal current.

Item or method step 450 refers to deactivating the DC undervoltage regulation or the DC overvoltage regulation when the DC voltage becomes higher than the user-specified or process-specified undervoltage limit or lower than the user-specified or process-specified overvoltage limit, respectively.

The deactivation criteria may also be configured to be defined as follows:

$$K ∈ [ {Γ}_{UV} ; {Γ}_{OV} ] . \qquad ( 5 )$$

Thus, when the DC undervoltage regulation or the DC overvoltage regulation is in the activated state, and, subsequently, the load reference K becomes lower than the undervoltage loading adjustment value Γ_{UV} or higher than the overvoltage loading adjustment value Γ_{OV}, the DC undervoltage regulation or the DC overvoltage regulation may be deactivated.

Preferably, after the deactivation, the DC undervoltage regulation or the DC overvoltage regulation returns to the inactivated state.

The method may be stopped at item 499.

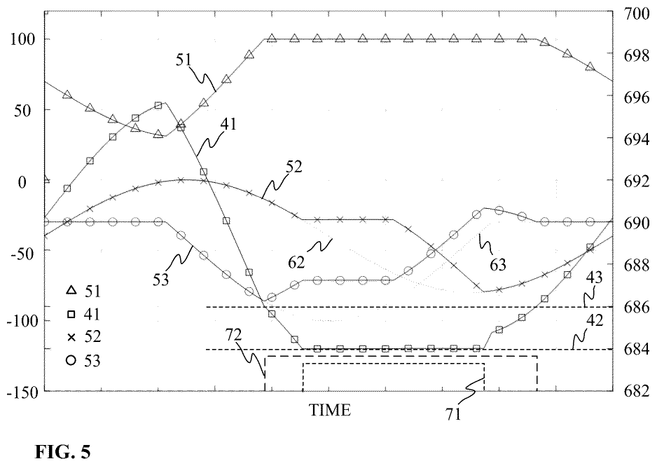

FIG. 5 illustrates operation of an electric power converter 100 that is configured with a DC undervoltage regulation and/or a DC overvoltage regulation as disclosed herein. The vertical axis on the left of the figure represents current in amperes. The vertical axis on the right of the figure represent DC voltage in volts. The invention is not limited to said current and/or voltage ranges or levels but can utilized in other current and voltage ranges or levels as well. The horizontal axis represents time, such as, for example, seconds.

The example of FIG. 5 illustrates an operation of an electric power converter 100 in a DC microgrid with one source, and two loads which both include an electric power converter 100 as described hereinabove (see also FIG. 3 with another configuration for reference). Marked with reference sign 51 is the current of provided by the source, that is the source current 51. Marked with reference sign 52 is the current of a first load configured, that is the first load current 52, with a DC undervoltage regulation and/or a DC overvoltage regulation as described hereinabove. Marked with reference sign 53 is the current of a second load, that is the second load current 53, configured with a DC undervoltage regulation and/or a DC overvoltage regulation as described hereinabove. Currents of the loads are shown as negative currents and the current of source as positive. The maximum source current 51 is 100 amperes.

The DC voltage is marked with reference sign 41, such as of a common DC bus. As the electric power converter 100 is connected to the common DC bus, the electric power converters 100 are configured to monitor the DC voltage, such as by voltage measurement or voltage sensor thereof. Activated state of the first load is marked with 71 whereas activated state of the second load is marked with 72.

Furthermore, marked with reference sign 42 is the undervoltage regulation limit 42 for the first load, that is the first undervoltage regulation limit, and reference sing 43 is the undervoltage regulation limit 43 for the second load, that is the second undervoltage regulation limit, when the DC undervoltage regulation is in the inactivated state. When the DC undervoltage regulation and/or the DC overvoltage regulation is in the inactivated state, the undervoltage regulation limits 42, 43 are droop-compensated, thus, essentially constant at 684 V and 686 V, respectively, as shown in FIG. 5. Even if the load currents 52, 53 are changing, the undervoltage regulation limits 42, 43 are substantially unchanged. The undervoltage regulation limits 42, 43 may, indeed, be user-specified or process-specified values.

Still further, the reference current of the first load is marked with 62, that is the first reference current 62, and the reference current of the second load with 63, that is the second reference current 63. As can be seen, the first load current 52 follows the first reference current 62 when the DC undervoltage regulation is in the inactivated state. Also, the second load current 53 follows the second reference current 63 when the DC undervoltage regulation is in the inactivated state. In this case, the load currents 52, 53 are shown to follow exactly the reference currents 62, 63 when DC undervoltage regulation is in the inactivated state, however, there may, in some cases, be some deviations due to characteristics of the control method used is said cases.

The operation of the DC undervoltage regulation in FIG. 5 is now described. In the beginning, the DC undervoltage regulation (and also the DC overvoltage regulation) is in the inactivated state. The DC voltage 41 is increasing up to a point when the source current 51 starts to increase mostly due to an increase in the second load current 53. As the source current 51 increases, the DC voltage 41 continues to decrease but is still higher than the first undervoltage regulation limit 42 and the second undervoltage regulation limit 43.

After a time period of decreasing DC voltage 41, the DC voltage 41 reaches the second undervoltage regulation limit 43, and thus, the DC undervoltage regulation of the second load activates. The second load current 53 starts to deviate from the second reference current 63, namely being lower than that in order to regulate the DC voltage 41 for it to not decrease. As can be seen, the DC voltage 41 continues to decrease but not as rapidly any more.

The regulation of the DC voltage is performed by the electric power converter 100 of the second load by adjusting the loading of the electric power converter 100 based on an undervoltage loading adjustment coefficient Γ_{UV_2} of the electric power converter 100 of the second load, wherein the undervoltage loading adjustment coefficient Γ_{UV_2} coefficient is based on a voltage difference between the second undervoltage regulation limit 43 and the DC voltage 41, and based on the undervoltage drooping coefficient ζ_{UV_2}, such as defined in accordance with equation (3A), for instance.

Even though the second load has the DC undervoltage regulation in the activated state, the DC voltage 41 continues to decrease in this example case but slower than before. After another time period of the decreasing DC voltage 41, the DC voltage 41 reaches the first undervoltage regulation limit 42, and thus, the DC undervoltage regulation of the first load activates. The first load current 52 starts to deviate from the first reference current 62, namely being lower than that in order to regulate the DC voltage 41 for it to not decrease. The regulation of the DC voltage is performed by the electric power converter 100 of the first load by adjusting the loading of the electric power converter 100 based on an undervoltage loading adjustment coefficient Γ_{UV_1} of the first load, wherein the undervoltage loading adjustment coefficient Γ_{UV_1} coefficient is based on a voltage difference between the first undervoltage regulation limit 42 and the DC voltage 41, and based on the undervoltage drooping coefficient ζ_{UV_1}, such as defined in accordance with equation (3A), for instance.

As can be seen, the DC voltage 41 plateaus to or sets to a constant value of 684 V which is equal to the first undervoltage regulation limit 42. During this time, both of the electric power converters 100 have the DC undervoltage regulation in the activated state as visible based on activation signals 71 and 72, and for both loads, the load current 52, 53 is less than the respective reference current 62, 63.

After yet another time period, it can be seen that the second reference current 63 begins to decrease, that is, becomes less negative. At the same time, the load current 53 starts to decrease because the decreasing second reference current 63 affects the lower limit of the undervoltage regulation voltage, for example, as defined in equation (4A), while the first current reference 63 as well as the first load current 53 increases (becomes more negative) based on the first reference current 62 affecting the lower limit of the undervoltage regulation voltage, for example, as defined in equation (4A). This continues until the DC voltage 41 begins to increase from the first undervoltage regulation limit 42 which means that the DC undervoltage regulation of the first load deactivates and is changed to the inactivated state. The deactivation of the DC undervoltage regulation happens when the load reference (the load reference K may be defined, for example, as a ratio of the reference current to a nominal current), in this case in relation to the first reference current 62, of the electric power converter 100 becomes lower than the undervoltage loading adjustment value Γ_{UV_1} when the DC voltage 41 becomes higher than the user-specified or process-specified undervoltage limit of 684 V. As can be seen, the first load current 52 becomes equal to the first reference current 62.

The deactivation of the DC undervoltage regulation of the electric power converter 100 of the second load happens later when the DC voltage 41 becomes higher than the second undervoltage regulation limit 43. The deactivation of the DC undervoltage regulation happens when the load reference (the load reference K may be defined, for example, as a ratio of the reference current to a nominal current), in this case in relation to the second reference current 63, of the electric power converter 100 becomes lower than the undervoltage loading adjustment value Γ_{UV_2} when the DC voltage 41 becomes higher than the user-specified or process-specified undervoltage limit of 686 V. As can be seen, the second load current 53 becomes equal to the second reference current 63.

FIG. 5 illustrates that the DC undervoltage regulation of the electric power converter 100 activates at the user-specified or process-specified undervoltage level (42 or 43). The droop-compensation ensures that the activation does not occur in wrong times. The DC overvoltage regulation would operate in the same way, however, for DC voltage becoming too high instead of too low.

In some embodiments, the electric power converter 100 may additionally be configured with undervoltage and overvoltage protection functions. The protection functions stop the converter 100 in case the DC voltage 41 goes too low that the converter 100 is not capable to operate anymore or dangerously high. There protection functions are, however, not corresponding to the DC undervoltage regulation and the DC overvoltage regulation functions as disclosed herein.

While the present disclosure has been illustrated and described and with respect to a particular embodiment thereof, it should be appreciated by those of ordinary skill in the art that various modifications to this disclosure may be made without departing from the spirit and scope of the present disclosure.

What is claimed is:

1. A method of a DC undervoltage regulation and/or a DC overvoltage regulation for an electric power converter, the method comprising:
monitoring a DC voltage by the electric power converter;
comparing the DC voltage to an undervoltage regulation limit and/or an overvoltage regulation limit defined at least by a user-specified or process-specified undervoltage limit and/or a user-specified or process-specified overvoltage limit, wherein, when the DC undervoltage regulation or the DC overvoltage regulation is in an inactivated state, the undervoltage regulation limit and/or the overvoltage regulation limit are/is at least partially, preferably completely, droop-compensated by utilizing an undervoltage drooping coefficient or an overvoltage drooping coefficient, respectively;
activating the DC undervoltage regulation or the DC overvoltage regulation as a response to the DC voltage reaching the undervoltage regulation limit or the overvoltage regulation limit, respectively, for changing the DC undervoltage regulation or the DC overvoltage regulation into an activated state;
regulating the DC voltage, when the DC undervoltage regulation or the DC overvoltage regulation is in the activated state, by adjusting loading of the electric power converter based on an undervoltage loading adjustment coefficient or an overvoltage loading adjustment coefficient, respectively, wherein the undervoltage loading adjustment coefficient and/or the overvoltage loading adjustment coefficient are/is based on a voltage difference between the undervoltage regulation limit or the overvoltage regulation limit, and the DC voltage, and based on the undervoltage drooping coefficient or the overvoltage drooping coefficient; and
deactivating the DC undervoltage regulation or the DC overvoltage regulation when the DC voltage becomes higher than the user-specified or process-specified undervoltage limit or lower than the user-specified or process-specified overvoltage limit, respectively.

2. The method of claim 1, wherein the droop-compensation is in relation to an adjustment of a reference DC voltage depending on the undervoltage drooping coefficient or the overvoltage drooping coefficient, and the loading of the electric power converter.

3. The method of claim 1, wherein, when the DC undervoltage regulation or the DC overvoltage regulation is in the inactivated state, the loading of the electric power converter is adjusted based on a load reference of the electric power converter.

4. The method of claim 2, wherein the adjusting of the loading comprises:
adjusting the loading to be at a lower level relative a load reference of the electric power converter, when the DC undervoltage regulation is in the activated state, and/or
adjusting the loading to be at a higher level relative a load reference of the electric power converter, when the DC overvoltage regulation is in the activated state.

5. The method of claim 1, wherein the undervoltage drooping coefficient and/or the overvoltage drooping coefficient are/is defined based on a predetermined DC voltage drop at a nominal load in relation to the undervoltage regulation limit and/or the overvoltage regulation limit, respectively, when the DC undervoltage regulation or the DC overvoltage regulation is in the inactivated state.

6. The method of claim 1, wherein, when the DC undervoltage regulation or the DC overvoltage regulation is in the inactivated state, the undervoltage regulation limit and/or the overvoltage regulation limit are/is configured to include the user-specified or process-specified undervoltage limit and/or the user-specified or process-specified overvoltage limit, respectively, and a droop-compensation term that is a function of the loading.

7. The method of claim 6, wherein the undervoltage loading adjustment coefficient and/or the overvoltage loading adjustment coefficient is a ratio of the voltage difference to a product of the undervoltage drooping coefficient or the overvoltage drooping coefficient, and the user-specified or process-specified undervoltage limit or the user-specified or process-specified overvoltage limit, respectively.

8. The method of claim 1, wherein,
the undervoltage regulation limit has a lower limit that is based on the undervoltage regulation limit when the DC undervoltage regulation is in the activated state, and a product of a load reference of the electric power converter and the undervoltage drooping coefficient, and/or
the overvoltage regulation limit has an upper limit that is based on the overvoltage regulation limit when the DC overvoltage regulation is in the activated state, and a product of a load reference of the electric power converter and the overvoltage drooping coefficient.

9. The method of claim 1, wherein a load reference of the electric power converter is defined as a ratio of a reference current to a nominal current.

10. The method of claim 1, comprises, when the DC undervoltage regulation or the DC overvoltage regulation is in the activated state,
the DC voltage is required to be lower than or equal to the undervoltage regulation limit, and/or
the DC voltage is required to be higher than or equal to the overvoltage regulation limit.

11. An electric power converter comprising:
a DC voltage bus,
a conversion circuitry connected to the DC voltage bus for providing an DC/AC, an AC/DC, or a DC/DC voltage conversion,
voltage determining means for determining a DC voltage of the DC voltage bus,
current determining means for determining a load current of the electric power converter; and
a controller that is configured to perform the method of claim 1.

12. The electric power converter of claim 11, wherein the controller is configured, when the DC undervoltage regulation or the DC overvoltage regulation is in the inactivated state, to control a loading of the electric power converter in accordance with a load reference of the electric power converter.

13. The electric power converter of claim 11, comprising a capacitor or a capacitor bank, or a battery or a battery bank connected to the DC voltage bus.

14. A DC microgrid comprising:
a common DC bus having a DC voltage,
one or several DC voltage sources connected to the common DC bus, and
one or several electric power converters of claim 10 connected to the common DC bus.

15. The DC microgrid of claim 14, arranged as a shipboard power system.
